(19) United States
(12) Patent Application Publication
(10) Pub. No.: US 2012/0252917 A1
(43) Pub. Date: Oct. 4, 2012

(54) POLYMER COMPOSITIONS, METHODS OF MAKING THE SAME, AND ARTICLES PREPARED FROM THE SAME

(75) Inventors: Srdjan Kisin, Horgen (CH); Timothy E. Clayfield, Waedenswil (CH)

(73) Assignee: Dow Global Technologies LLC, Midland, MI (US)

(21) Appl. No.: 13/515,696

(22) PCT Filed: Dec. 22, 2010
(86) PCT No.: PCT/US10/61830

§ 371 Date: Jun. 13, 2012

Related U.S. Application Data
(60) Provisional application No. 61/290,051, filed on Dec. 24, 2009.

(51) Int. Cl. C08L 23/20

(52) U.S. Cl. 521/140

(57) ABSTRACT

The invention provides a composition comprising at least the following: A) an ethylene/α-olefin/polyene interpolymer, B) an ethylene/α-olefin copolymer, C) optionally at least one filler, D) at least one crosslinking agent, E) at least one blowing agent.

### REFERENCE TO RELATED APPLICATIONS

This application claims the benefit of U.S. Provisional Application No. 61/290,051, filed on Dec. 24, 2009, and fully incorporated herein by reference.

### BACKGROUND OF THE INVENTION

The invention relates to crosslinked foams formed from compositions containing an ethylene/α-olefin/polyene interpolymer and an ethylene/α-olefin copolymer. The compositions are well suited for profiles in automotive weather-strip applications.

As a result of an increase demand for automotive parts of reduced weight, solid rubber profiles for automotive weather-strips are being replaced with foamed profiles of lower density and consequently of lower weight. Thus, there is a need for compositions that can be used to form low density foams with maintained mechanical properties, close to, or equal to, those of the current solid counterparts.

U.S. Pat. No. 5,932,659 discloses polymer blends, which can be used both in foamed and unfoamed states, and which are formed from a composition containing a “single-site catalyzed” polyolefin with a density less than 0.878 g/cm³, and up to 40 percent of a polyolefin. The polymer blends can be crosslinked, and are foamable. See also U.S. Pat. No 6,004,647.

International Publication No. WO 2000/069930 discloses high crystalline ethylene/α-olefin/polyene interpolymers, which can be grafted and crosslinked. These interpolymers can be used in blends with other polymers.

U.S. Pat. No. 6,303,666 discloses a process for the production of expanded olefinic thermoplastic elastomer products, which are disclosed as having good external appearance, flexibility, and heat resistance. This process uses carbon dioxide as a blowing agent.

International Publication No. WO 2003/009999 discloses a method for forming a composite extrusion for use as a vehicle weather strip. The method comprises: (1) extruding a thermoset elastomer rubber to form a weather strip main body member (A), (2) extruding a crosslinkable thermoplastic to form an abrasion-resistant decorative layer (B), and (3) contacting B to A, and at least partially curing the thermoset elastomer rubber. Component B may be a crosslinkable ethylene/α-olefin copolymer, or a copolymerized ethylene-styrene interpolymer.

European Patent EP1007591B1 discloses a crosslinking process comprising the following: (a) forming a polymeric admixture, including a polyolefin that has been prepared using a single-site catalyst and at least a crosslinking amount of a poly(sulfonyl azide) crosslinking agent; (b) shaping the resulting admixture; and (c) heating the resulting shaped admixture to a temperature of at least the decomposition temperature of the crosslinking agent. Step (a) may include forming a foamable melt polymer by admixing and heating a decomposable chemical blowing agent.

U.S. Pat. No. 6,111,021 discloses a vulcanizable rubber composition, comprising a blend, which is prepared by micro-dispersing a polyolefin resin (B) in an ethylene/alpha-olefin/nonconjugated polyene copolymer (A), and in which the mean diameter of dispersed particles of the polyolefin resin (B) is 2 μm or below. The (B) to (A) weight ratio ranges from 5/95 to 50/50.

Additional elastomers and/or compositions containing the same, are disclosed in the following: U.S. Pat. No. 6,710,129; U.S. Pat. No. 6,325,956; U.S. Pat. No. 5,728,744; European Patent Application EP0775727A1; European Patent Application EP0046285A1; JP2002212349A (Abstract); and JP7138378A (Abstract).

There remains a need for compositions that can be used to form low density foams with maintained mechanical properties, close to, or equal to, those of the current solid counterparts. There is a further need for such compositions that can be formed using a “one-step” mixing process. These needs have been met by the following invention.

### SUMMARY OF THE INVENTION

The invention provides a composition comprising at least the following:
A) an ethylene/α-olefin/polyene interpolymer,
B) an ethylene/α-olefin copolymer,
C) optionally at least one filler,
D) at least one crosslinking agent,
E) at least one blowing agent.

### BRIEF DESCRIPTION OF THE DRAWINGS

FIG. 1 depicts “density versus cure temperature” for crosslinked foams formed from an inventive composition (Example 1) and a comparative composition (Example 2).

FIG. 2 depicts “Shore A hardness versus cure temperature” for crosslinked foams formed from an inventive composition (Example 1) and a comparative composition (Example 2).

FIG. 3 is a picture of the top surface view of a foam formed from Comparative Example 3.

FIG. 4 is a picture of the top surface view of a foam formed from Inventive Example 1.

### DETAILED DESCRIPTION OF THE INVENTION

As discussed above, the invention provides a composition comprising at least the following:
A) an ethylene/α-olefin/polyene interpolymer,
B) an ethylene/α-olefin copolymer,
C) optionally at least one filler,
D) at least one crosslinking agent,
E) at least one blowing agent.

In one embodiment, the absolute difference in the solubility parameters of component A and component B is less than, or equal to, 0.15 (cal/cm³)“^{1/2}, preferably less than, or equal to, 0.14 (cal/cm³)”^{1/2}, more preferably less than, or equal to, 0.10 (cal/cm³)^{1/2}.

In one embodiment, component A is present in an amount greater than, or equal to, 75 weight percent, preferably greater than, or equal to, 80 weight percent, more preferably greater than, or equal to, 85 weight percent, based on the weight of component A and component B.

In one embodiment, component A is present in an amount less than, or equal to, 100 weight percent, preferably less than, or equal to, 95 weight percent, more preferably less than, or equal to, 90 weight percent, based on the weight of component A and component B.

In one embodiment, components A and B comprise at least 80 weight percent, preferably at least 90 weight percent, more preferably at least 95 weight percent, based on the weight of all the polymer components (organic polymeric components) of the composition.

In one embodiment, components A and B comprise at less than, or equal to, 100 weight percent, preferably less than, or equal to, 99.5 weight percent, more preferably less than, or equal to, 99 weight percent, based on the weight of all the polymer components of the composition.

In one embodiment, components A and B comprise from 10 to 40 weight percent, preferably from 15 to 35 weight percent, and more preferably from 20 to 30 weight percent of the composition (based on the weight of the composition).

In one embodiment, component A is present in an amount greater than 15 weight percent, preferably greater than 18 weight percent, more preferably greater than 20 weight percent, based on the weight of the composition.

In one embodiment, component A is present in an amount less than 40 weight percent, preferably less than 35 weight percent, more preferably less than 30 weight percent, based on the weight of the composition.

In one embodiment, component B is present in an amount from 1 to 10 weight percent, preferably from 2 to 8 weight percent, more preferably from 3 to 6 weight percent, and even more preferably from 3.5 to 5 weight percent, based on the weight of the composition.

In one embodiment, the weight ratio of “component A/component B” is from 2/1 to 10/1, preferably from 4/1 to 9/1, more preferably from 5/1 to 8/1, even more preferably from 5.5/1 to 7/1.

In one embodiment, the composition comprises at least one filler. In a further embodiment, the composition comprises less than 55 weight percent, preferably less than 50 weight percent, more preferably less than 45 weight percent, even more preferably less than 40 weight percent, and even more preferably less than 35 weight percent of the filler, based on the weight of the composition. In a further embodiment, the filler is carbon black.

In one embodiment, the composition comprises at least one filler. In a further embodiment, the composition comprises greater than 20 weight percent, preferably greater than 25 weight percent, and more preferably greater than 30 weight percent, of the filler, based on the weight of the composition. In a further embodiment, the filler is carbon black.

In one embodiment, the composition comprises at least one filler. In a further embodiment, the composition comprises greater than 30 weight percent, preferably greater than 36 weight percent, and more preferably greater than 40 weight percent, of the filler, based on the weight of the composition. In a further embodiment, the filler is carbon black.

In one embodiment, the composition comprises at least one filler. In a further embodiment, the composition comprises from 20 to 50 weight percent, preferably from 25 to 45 weight percent, and more preferably from 30 to 40 weight percent of the filler. In a further embodiment, the filler is carbon black.

In one embodiment, the composition comprises at least one filler. In a further embodiment, the filler is selected from the group consisting of carbon black, CaCO3, silica, and combinations thereof. In a further embodiment, the filler is selected from the group consisting of carbon black, CaCO3, and combinations thereof.

The crosslinking agent should preferably form crosslinks between molecules of the ethylene/α-olefin/polyene interpolymer (Component A), and should preferably be unreactive towards the ethylene/α-olefin copolymer (Component B).

In one embodiment, the at least one crosslinking agent is selected from the group consisting of sulfur crosslinking agents, phenolic crosslinking agents, azide crosslinking agents, and combinations thereof. In a further embodiment, the crosslinking agent is selected from the group consisting of sulfur crosslinking agents. In a preferred embodiment, the composition does not comprise a peroxide crosslinker.

Crosslinking agents can be based on sulfur or sulfur donor curing compounds, phenolic systems, azide systems, and preferably based on sulfur or sulfur donor curing compounds.

In one embodiment, the at least one blowing agent is selected from the group consisting of chemical blowing agents.

In one embodiment, the chemical blowing agent is selected from the group consisting of sulfonyl hydrazides, azodicarbonamides, and a combination thereof.

In one embodiment, the at least one blowing agent is selected from the group consisting of oxy-bis benzene sulphonyl hydrazide, azodicarbonamide, and combinations thereof.

In a preferred embodiment, the at least one blowing agent is a chemical blowing agent that has a decomposition temperature greater than 150° C. In a further embodiment, the chemical blowing agent is a sulfonyl hydrazide, an azodicarbonamide, or a combination thereof.

In one embodiment, the composition further comprises at least one oil. In a further embodiment, the oil is present in an amount greater than 10 weight percent, preferably greater than 15 weight percent, and more preferably greater than 20 weight percent, based on the weight of the composition.

In one embodiment, the oil is present in an amount less than 35 weight percent, preferably less than 30 weight percent, and more preferably less than 25 weight percent, based on the weight of the composition.

In one embodiment, the composition comprises from 10 to 40 weight percent, preferably from 15 to 35 weight percent, and more preferably from 20 to 30 weight percent of an oil (based on the weight of the composition).

In one embodiment, the ethylene/alpha-olefin/polyene interpolymer has a Mooney Viscosity from 40 to 200, preferably from 60 to 180, more preferably from 80 to 160, and even more preferably from 100 to 150 (ML1+4 at 125° C.). In a further embodiment, the ethylene/alpha-olefin/polyene interpolymer is a EPDM. In a further embodiment, the diene is ENB (5-ethylidene-2-norbornene). In a further embodiment, the EPDM comprises, in polymerize form, from 0.5 to 6 weight percent, preferably from 1 to 5 weight percent of the ENB, based on the weight of the EPDM. Mooney viscosity is that of the neat interpolymer (or calculated viscosity of neat polymer for polymers that contain a filler, such as carbon black, and/or an oil). The neat polymer refers to the polymer without filler and without oil.

In one embodiment, the ethylene/α-olefin copolymer has a density from 0.85 g/cc to 0.93 g/cc, and preferably from 0.86 to 0.91 g/cc, more preferably from 0.87 to 0.90 g/cc, even more preferably from 0.87 to 0.89 g/cc. In a further embodiment, the α-olefin is selected from propylene, 1-butene, 1-hexene or 1-octene, preferably from 1-hexene, 1-octene or 1-butene, and more preferably from 1-octene or 1-butene.

In one embodiment, the ethylene/α-olefin copolymer has a melt index (12) from 0.2 to 10 g/10 min, preferably from 0.3 to 5 g/10 min, more preferably from 0.5 to 2 g/10 min. In a further embodiment, the α-olefin is selected from propylene, 1-butene, 1-hexene or 1-octene, and preferably from 1-butene, 1-hexene or 1-octene, and more preferably from 1-octene or 1-butene.

In one embodiment, ethylene/α-olefin copolymer is a homogeneously branched linear ethylene/α-olefin copolymer or a homogeneously branched, substantially linear ethylene/α-olefin copolymer. In a further embodiment, the α-olefin is selected from propylene, 1-butene, 1-hexene or 1-octene, and preferably from 1-butene, 1-hexene or 1-octene, and more preferably from 1-octene or 1-butene.

In one embodiment, ethylene/α-olefin copolymer is a homogeneously branched, substantially linear ethylene/α-olefin copolymer. In a further embodiment, the α-olefin is selected from propylene, 1-butene, 1-hexene or 1-octene, and preferably from 1-butene, 1-hexene or 1-octene, and more preferably from 1-octene or 1-butene.

In one embodiment, ethylene/α-olefin copolymer is a homogeneously branched, linear ethylene/α-olefin copolymer. In a further embodiment, the α-olefin is selected from propylene, 1-butene, 1-hexene or 1-octene, and preferably from 1-butene, 1-hexene or 1-octene, and more preferably from 1-octene or 1-butene.

The ethylene/α-olefin/polyene interpolymer (Component A) and the ethylene/α-olefin copolymer (Component B) of the inventive composition are not modified with one or more functional groups. For example, these polymers are not silane-grafted, maleic anhydride-grafted, nor TEMPO-grafted polymers. It is understood that some functionality may be incorporated into component A (preferably not into component B) after the inventive composition undergoes a crosslinking reaction.

In one embodiment, the composition comprises from 70 to 95 phr, preferably 75 to 90 phr, of an EPDM, and preferably the diene is ENB; and from 5 to 30 phr, preferably from 10 to 20 phr, of an ethylene/α-olefin copolymer; from 1 to 10 phr of a crosslinking agent; from 0.5 to 5 phr of a blowing agent, and preferably a chemical blowing agent; from greater than 0 to 250 phr, preferably from 20 to 200 phr, more preferably from 50 to 150 phr, of a filler; and from greater than 0 to 200 phr, preferably from 10 150 phr, more preferably from 50 to 100 phr, of an oil. In a further embodiment, the absolute difference in the solubility parameters of the EPDM and the ethylene/α-olefin copolymer is less than, or equal to, 0.15 (cal/cm³)^{1/2}, preferably less than, or equal to, 0.10 (cal/cm³)^{1/2}. In a further embodiment, ethylene/α-olefin copolymer has a density less than, or equal to, 0.92 g/cc, preferably less than, or equal to, 0.91 g/cc (1 cc=1 cm³). In a further embodiment, the ethylene/α-olefin copolymer is an ethylene/1-octene copolymer or an ethylene/1-butene copolymer.

The invention also provides an article comprising at least one component formed from an inventive composition. In one embodiment, the article is an automotive part. In a further embodiment, the article is a weatherstrip profile.

The invention also provides a crosslinked foam formed from an inventive composition. In one embodiment, the crosslinked foam has a density less than, or equal to, 1.05 g/cc, preferably less than, or equal to, 1.02 g/cc, and more preferably less than, or equal to, 1.01 g/cc. In another embodiment, the crosslinked foam has a Shore A hardness value greater than, or equal to, 49, preferably greater than, or equal to, 50, more preferably greater than, or equal to 52, and even more preferably greater than, or equal to 55. In a further embodiment, the crosslinked foam has a density less than, or equal to, 1.05 g/cc, preferably less than, or equal to, 1.02 g/cc, and more preferably less than, or equal to, 1.01 g/cc, and a Shore A hardness value greater than, or equal to, 49, preferably greater than, or equal to, 50, more preferably greater than, or equal to 52, and even more preferably greater than, or equal to 55.

The invention also provides an article comprising at least one component formed from an inventive crosslinked foam. In one embodiment, the article is an automotive part. In a further embodiment, the article is a weatherstrip profile.

An inventive composition may comprise a combination of two or more embodiments as described herein.

An inventive article may comprise a combination of two or more embodiments as described herein.

An inventive crosslinked foam may comprise a combination of two or more embodiments as described herein.

It has been discovered that an inventive composition comprising an ethylene/α-olefin/polyene interpolymer, as described herein, and an ethylene/α-olefin copolymer, as described herein, can be extruded, crosslinked and foamed, to form low density foams with excellent mechanical properties.

The inventive compositions can be used for an automotive rubber part, where weight reduction is needed, and where no compromise on mechanical properties can be tolerated. Other applications include foamed, flexible profiles for the building and construction industry. The inventive compositions can also be formed using a “one-step” mixing process. Thus, the inventive compositions are also less expensive to produce, compared to current resins containing a high density dispersed phase in an elastomer. Because of the high melting temperature of the dispersed phase, such resins can only be made through an additional compounding process, increasing their costs significantly.

### Ethylene/α-Olefin/Polyene Interpolymers

The ethylene/α-olefin/polyene interpolymers comprise, in polymerize form, ethylene, an α-olefin, and a polyene. The polyene may be conjugated or nonconjugated, and is preferably nonconjugated. Suitable examples of α-olefins include the C3-C10 α-olefins, and preferably propylene. Suitable examples of nonconjugated polyenes include the C4-C40 nonconjugated polyenes.

The α-olefin may be either an aliphatic or an aromatic compound. The α-olefin is preferably a C3-C20 aliphatic compound, preferably a C3-C16 aliphatic compound, and more preferably a C3-C10 aliphatic compound. Preferred C3-C10 aliphatic α-olefins are selected from the group consisting of propylene, 1-butene, 1-hexene and 1-octene, and more preferably propylene. In a preferred embodiment, the interpolymer is an ethylene/propylene/diene (EPDM) terpolymer. In a further embodiment, the diene is 5-ethylidene-2-norbornene (ENB).

In one embodiment, the polyene is a nonconjugated diene. Illustrative nonconjugated dienes include straight chain acyclic dienes, such as 1,4-hexadiene and 1,5-heptadiene; branched chain acyclic dienes, such as 5-methyl-1,4-hexadiene, 2-methyl-1,5-hexadiene, 6-methyl-1,5-heptadiene, 7-methyl-1,6-octadiene, 3,7-dimethyl-1,6-octadiene, 3,7-dimethyl-1,7-octadiene, 5,7-dimethyl-1,7-octadiene, 1,9-decadiene, and mixed isomers of dihydromyrcene; single ring alicyclic dienes such as 1,4-cyclohexadiene, 1,5-cyclooctadiene and 1,5-cyclododecadiene; multi-ring alicyclic fused and bridged ring dienes, such as tetrahydroindene, methyl tetrahydroindene; alkenyl, alkylidene, cycloalkenyl and cycloalkylidene norbornenes such as 5-methylene-2-norbornene (MNB), 5-ethylidene-2-norbornene (ENB), 5-vinyl-2-norbornene, 5-propenyl-2-norbornene, 5-isopropylidene-2-norbornene, 5-(4-cyclopentenyl)-2-norbornene, and 5-cyclohexylidene-2-norbornene. The diene is preferably a nonconjugated diene selected from the group consisting of ENB, dicyclopentadiene, 1,4-hexadiene, 7-methyl-1,6-octadiene, and preferably, ENB, dicyclopentadiene and 1,4-hexadiene, more preferably ENB and dicyclopentadiene, and even more preferably ENB.

In one embodiment, the ethylene/α-olefin/polyene interpolymer is prepared in the presence of a single site catalyst, such as a constrained geometry catalyst (CGC), for example, a monocyclopentadienyl titanium complex; or a post metallocene catalyst. Some examples of constrained geometry catalysts are described in U.S. Pat. Nos. 5,272,236 and 5,278,272. Some examples of post metallocene catalysts are described in U.S. Publication No. 2005/0164872 and International Publication No. WO 2007/136494.

In one embodiment, the ethylene/α-olefin/polyene interpolymer is prepared the presence of a constrained geometry catalyst (CGC). In a further embodiment, the interpolymer is an EPDM terpolymer. In a further embodiment, the diene is (ENB). In another embodiment, the ethylene/α-olefin/polyene interpolymer is prepared the presence of a post metallocene catalyst. In a further embodiment, the interpolymer is an EPDM terpolymer. In a further embodiment, the diene is (ENB).

In one embodiment, the ethylene/α-olefin/polyene interpolymer is prepared in the presence of a partitioning agent. In a further embodiment, the partitioning agent is carbon black. In a preferred embodiment, the interpolymer is an EPDM. In a further embodiment, the diene is (ENB).

In one embodiment, the ethylene/α-olefin/polyene interpolymer is prepared in the presence of a constrained geometry catalyst and a partitioning agent. In a further embodiment, the partitioning agent is carbon black. In a preferred embodiment, the interpolymer is an EPDM terpolymer. In a further embodiment, the diene is (ENB).

In one embodiment, the ethylene/α-olefin/polyene interpolymer is prepared in the presence of a post metallocene catalyst and a partitioning agent. In a further embodiment, the partitioning agent is carbon black. In a preferred embodiment, the interpolymer is an EPDM terpolymer. In a further embodiment, the diene is (ENB).

In one embodiment, the ethylene/α-olefin/polyene interpolymer comprises a majority amount of polymerized ethylene, based on the weight of the interpolymer.

In one embodiment, the ethylene/α-olefin/polyene interpolymer has a molecular weight distribution (Mw/Mn) from 1.5 to 5, preferably from 2 to 4.5 and more preferably from 2 to 4. All individual values and subranges from 1.5 to 5 are included herein and disclosed herein. In a preferred embodiment, the interpolymer is an EPDM. In a further embodiment, the diene is (ENB).

In one embodiment, the ethylene/α-olefin/polyene interpolymer has a molecular weight distribution (Mw/Mn) from 2 to 3.5, preferably from 2 to 3 and more preferably from 2 to 2.5. All individual values and subranges from 2 to 3.5 are included herein and disclosed herein. In a preferred embodiment, the interpolymer is an EPDM. In a further embodiment, the diene is (ENB).

In one embodiment, the ethylene/α-olefin/polyene interpolymer has a Mooney viscosity, ML(1+4) at 125° C., greater than, or equal to, 40, preferably greater than, or equal to, 60, more preferably greater than, or equal to 80, and even more preferably greater than, or equal to 100. In a preferred embodiment, the interpolymer is an EPDM. In a further embodiment, the diene is (ENB).

In one embodiment, the ethylene/α-olefin/polyene interpolymer has a Mooney viscosity, ML(1+4) at 125° C., less than 200, preferably less than, or equal to, 180, more preferably less than, or equal to, 160. In a preferred embodiment, the interpolymer is an EPDM. In a further embodiment, the diene is (ENB).

Mooney viscosity is that of the neat interpolymer (or-calculated viscosity of neat polymer for polymers that contain a filler, such as carbon black, and/or an oil). The neat polymer refers to the polymer without filler and without oil.

An ethylene/α-olefin/polyene interpolymer may comprise a combination of two or more embodiments as described herein.

An ethylene/alpha-olefin/diene interpolymer may comprise a combination of two or more embodiments as described herein.

An EPDM terpolymer may comprise a combination of two or more embodiments as described herein.

### Ethylene/α-Olefin Copolymers

Suitable ethylene/α-olefin copolymers include heterogeneous linear ethylene/α-olefin copolymers, homogeneously branched linear ethylene/α-olefin copolymers, and homogeneously branched substantially linear ethylene/α-olefin copolymers; and preferably homogeneously branched linear ethylene/α-olefin copolymers, and homogeneously branched substantially linear ethylene/α-olefin copolymers; and more preferably homogeneously branched substantially linear ethylene/α-olefin copolymers. Respective polymers can be prepared with Ziegler-Natta catalysts, metallocene or vanadium-based single-site catalysts, or constrained geometry single-site catalysts. Preferred α-olefins have from 3 to 18 carbon atoms, more preferably from 4 to 8 carbon atoms, and include propylene, 1-butene, 4-methyl-1-pentene, 1-hexene, and 1-octene, and preferably propylene, 1-butene, 1-hexene and 1-octene, and more preferably 1-butene, 1-hexene and 1-octene, and more preferably 1-butene and 1-octene.

In one embodiment, the ethylene/α-olefin copolymer has a melt index (1₂) less than, or equal to, 20 g/10 min, preferably less than, or equal to 10 g/10 min, more preferably less than, or equal to 5 g/10 min, and even more preferably less than, or equal to 2 g/10 min, as determined using ASTM D-1238-04 (190° C., 2.16 kg load). In a further embodiment, the ethylene/α-olefin copolymer is a homogeneously branched linear ethylene/α-olefin copolymer or a homogeneously branched substantially linear ethylene/α-olefin copolymer, and preferably a homogeneously branched substantially linear ethylene/α-olefin copolymer.

In one embodiment, the ethylene/α-olefin copolymer has a melt index (1₂) greater than, or equal to, 0.1 g/10 min, preferably greater than, or equal to 0.2 g/10 min, and more preferably greater than, or equal to 0.5 g/10 min, as determined using ASTM D-1238-04 (190° C., 2.16 kg load). In a further embodiment, the ethylene/α-olefin copolymer is a homogeneously branched linear ethylene/α-olefin copolymer or a homogeneously branched substantially linear ethylene/α-olefin copolymer, and preferably a homogeneously branched substantially linear ethylene/α-olefin copolymer.

In one embodiment, the ethylene/α-olefin copolymer has a melt index (I₂) from 0.1 g/10 min to 20 g/10 min, preferably from 0.2 g/10 min to 10 g/10 min, and more preferably from 0.3 g/10 min to 5 g/10 min, and even more preferably from 0.5 g/10 min to 2 g/10 min, as determined using ASTM D-1238-04 (190° C., 2.16 kg load). All individual values and subranges from 0.1 g/10 min to 20 g/10 min are included herein and disclosed herein. In a further embodiment, the ethylene/α-olefin copolymer is a homogeneously branched linear ethylene/α-olefin copolymer or a homogeneously branched substantially linear ethylene/α-olefin copolymer, and preferably a homogeneously branched substantially linear ethylene/α-olefin copolymer.

In one embodiment, the ethylene/α-olefin copolymer has a density less than, or equal to, 0.93 g/cm³, preferably less than, or equal to, 0.92 g/cm³, more preferably less than, or equal to, 0.91 g/cm³, and even more preferably less than, or equal to, 0.89 g/cm³. In a further embodiment, the ethylene/α-olefin copolymer is a homogeneously branched linear ethylene/α-olefin copolymer or a homogeneously branched substantially linear ethylene/α-olefin copolymer, and preferably a homogeneously branched substantially linear ethylene/α-olefin copolymer.

In one embodiment, the ethylene/α-olefin copolymer has a density greater than, or equal to, 0.85 g/cm³, preferably greater than, or equal to, 0.86 g/cm³, and more preferably greater than, or equal to, 0.87 g/cm³. In a further embodiment, the ethylene/α-olefin copolymer is a homogeneously branched linear ethylene/α-olefin copolymer or a homogeneously branched substantially linear ethylene/α-olefin copolymer, and preferably a homogeneously branched substantially linear ethylene/α-olefin copolymer.

In one embodiment, the ethylene/α-olefin copolymer has a density from 0.85 g/cm³ to 0.93 g/cm³, preferably from 0.86 g/cm³ to 0.91 g/cm³, and more preferably from 0.87 g/cm³ to 0.90 g/cm³. All individual values and subranges from 0.85 g/cm³ to 0.93 g/cm³ are included herein and disclosed herein. In a further embodiment, the ethylene/α-olefin copolymer is a homogeneously branched linear ethylene/α-olefin copolymer or a homogeneously branched substantially linear ethylene/α-olefin copolymer, and preferably a homogeneously branched substantially linear ethylene/α-olefin copolymer.

In one embodiment, the ethylene/α-olefin copolymer is a heterogeneous linear ethylene/α-olefin copolymer. Heterogeneous linear ethylene/α-olefin copolymers include linear low density polyethylene (LLDPE), ultra-low density polyethylene (ULDPE), and very low density polyethylene (VLDPE).

In one embodiment, the ethylene/α-olefin copolymer is a homogeneously branched linear ethylene/α-olefin copolymer or a homogeneously branched substantially linear ethylene/α-olefin copolymer, and preferably a homogeneously branched substantially linear ethylene/α-olefin copolymer.

The terms “homogeneous” and “homogeneously-branched” are used in reference to an ethylene/α-olefin copolymer, in which the α-olefin comonomer is randomly distributed within a given polymer molecule, and all of the polymer molecules have the same or substantially the same comonomer/ethylene ratio. The homogeneously branched ethylene/α-olefin copolymers include homogeneously branched linear ethylene/α-olefin copolymers, and homogeneously branched substantially linear ethylene/α-olefin copolymers.

Included amongst the homogeneously branched linear ethylene/α-olefin copolymers are ethylene copolymers, which lack long chain branching (or measurable amounts of long chain branching), but do have short chain branches, derived from the comonomer polymerized into the copolymer, and which comonomer is homogeneously distributed, both within the same polymer chain, and between different polymer chains. That is, homogeneously branched linear ethylene/α-olefin copolymers lack long chain branching, just as is the case for the linear low density ethylene/α-olefin copolymers, and can be made using “uniform branching distribution” polymerization processes, as described, for example, by Elston in U.S. Pat. No. 3,645,992. Commercial examples of homogeneously branched linear ethylene/α-olefin copolymers include TAFMER polymers supplied by the Mitsui Chemical Company, and EXACT polymers supplied by the ExxonMobil Chemical Company.

As discussed above, the homogeneously branched linear ethylene/α-olefin copolymers are described, for example, by Elston in U.S. Pat. No. 3,645,992, and subsequent processes to produce such polymers, using metallocene catalysts, have been developed, as shown, for example, in EP 0 129 368, EP 0 260 999, U.S. Pat. No. 4,701,432; U.S. Pat. No. 4,937,301; U.S. Pat. No. 4, 935,397; U.S. Pat. No. 5,055,438; and WO 90/07526; each fully incorporated herein by reference.

The homogeneously branched substantially linear ethylene/α-olefin copolymers are described in, for example, U.S. Pat. Nos. 5,272,236; 5,278,272; 6,054,544; 6,335,410 and 6,723,810; each fully incorporated herein by reference. The substantially linear ethylene/α-olefin copolymers are those in which the comonomer is randomly distributed within a given polymer molecule, and in which all of the polymer molecules have the same or substantially the same comonomer/ethylene ratio. In addition, the substantially linear ethylene/α-olefin copolymers have long chain branching (chain branch has more carbon atoms than a branched formed by the incorporation of one comonomer into the polymer backbone). The long chain branches have the same comonomer distribution as the polymer backbone, and can have about the same length as the length of the polymer backbone. “Substantially linear,” typically, is in reference to a polymer that is substituted, on average, with 0.01 long chain branches per 1000 carbons to 3 long chain branches per 1000 carbons. Polymers include the ENGAGE Polyolefin Elastomers available from The Dow Chemical Company. In contrast to the homogeneously branched substantially linear ethylene/α-olefin copolymers, the homogeneously branched linear ethylene/α-olefin copolymers lack measurable or demonstrable long chain branches.

The homogeneously branched substantially linear ethylene/α-olefin copolymers form a unique class of homogeneously branched ethylene polymers. They differ substantially from the well-known class of conventional, homogeneously branched linear ethylene/α-olefin copolymers, described by Elston in U.S. Pat. No. 3,645,992, and, moreover, they are not in the same class as conventional heterogeneous, “Ziegler-Natta catalyst polymerized” linear ethylene/α-olefin copolymers (for example, LLDPE, ULDPE and VLDPE), made, for example, using the technique disclosed by Anderson et al., in U.S. Pat. No. 4,076,698); nor are they in the same class as high pressure, free-radical initiated, highly branched polyethylenes, such as, for example, low density polyethylene (LDPE), ethylene-acrylic acid (EAA) copolymers, and ethylene vinyl acetate (EVA) copolymers.

The homogeneously branched, substantially linear ethylene/α-olefin copolymers have excellent processability, even though they have a relatively narrow molecular weight distribution. Surprisingly, the melt flow ratio (I₁₀/I₂), according to ASTM D 1238-04, of the substantially linear ethylene/α-olefin copolymers can be varied widely, and essentially independently of the molecular weight distribution (M_{w}/Mₙ or MWD). This surprising behavior is completely contrary to conventional homogeneously branched linear ethylene/α-olefin copolymers, such as those described, for example, by Elston in U.S. Pat. No. 3,645,992, and heterogeneously branched “conventional Ziegler-Natta polymerized” linear ethylene/α-olefin copolymers, such as those described, for example, by Anderson et al., in U.S. Pat. No. 4,076,698. Unlike the substantially linear ethylene/α-olefin copolymers, linear ethylene/α-olefin copolymers (whether homogeneously or heterogeneously branched) have rheological properties, such that, as the molecular weight distribution increases, the I₁₀/I₂ value also increases.

“Long chain branching (LCB)” can be determined by conventional techniques known in the industry, such as ¹³C nuclear magnetic resonance (¹³C NMR) spectroscopy, using, for example, the method of Randall (Rev. Micromole. Chem. Phys., 1989, C29 (2&3), p. 285-297). Two other methods are gel permeation chromatography, coupled with a low angle laser light scattering detector (GPC-LALLS), and gel permeation chromatography, coupled with a differential viscometer detector (GPC-DV). The use of these techniques for long chain branch detection, and the underlying theories, have been well documented in the literature. See, for example, Zimm, B. H. and Stockmayer, W. H., J. Chem. Phys., 17,1301(1949), and Rudin, A., Modern Methods of Polymer Characterization, John Wiley & Sons, New York (1991) pp. 103-112.

The homogeneous branched ethylene/α-olefin copolymers will preferably have a single melting peak, as measured using Differential Scanning calorimetry (DSC), in contrast to heterogeneously branched ethylene/α-olefin copolymers, which have two or more melting peaks, due to the heterogeneously branched polymer's broad short chain branching distribution.

In one embodiment, the ethylene/α-olefin copolymer has a molecular weight distribution (M_{w}/Mₙ) less than, or equal to, 5, preferably less than, or equal to, 4, and more preferably less than, or equal to, 3. In another embodiment, the ethylene/α-olefin copolymer has a molecular weight distribution (M_{w}/Mₙ) greater than, or equal to, 1.1, preferably greater than, or equal to, 1.2, and more preferably greater than, or equal to, 1.5. In a further embodiment, the ethylene/α-olefin copolymer is a homogeneously branched linear ethylene/α-olefin copolymer or a homogeneously branched substantially linear ethylene/α-olefin copolymer, and preferably a homogeneously branched substantially linear ethylene/α-olefin copolymer.

In one embodiment, the ethylene/α-olefin copolymer has a molecular weight distribution from 1.1 to 5, and preferably from 1.2 to 4, and more preferably from 1.5 to 3. All individual values and subranges from 1.1 to 5 are included herein and disclosed herein. In a further embodiment, the ethylene/α-olefin copolymer is a homogeneously branched linear ethylene/α-olefin copolymer or a homogeneously branched substantially linear ethylene/α-olefin copolymer, and preferably a homogeneously branched substantially linear ethylene/α-olefin copolymer.

An ethylene/α-olefin copolymer may comprise a combination of two or more embodiments as described herein.

### Additives

An inventive composition may comprise one or more additives. Suitable additives include, but are not limited to, fillers, antioxidants, UV stabilizers, flame retardants, plasticizers or oils, colorants or pigments, and combinations thereof.

Fillers include, but are not limited to, carbon black; silicates of aluminum, magnesium, calcium, sodium, potassium and mixtures thereof; carbonates of calcium, magnesium and mixtures thereof; oxides of silicon, calcium, zinc, iron, titanium, and aluminum; sulfates of calcium, barium, and lead; alumina trihydrate; magnesium hydroxide; phenol-formaldehyde, polystyrene, and poly(alphamethyl)-styrene resins, natural fibers, synthetic fibers, and the like.

Plasticizers include, but are not limited to, petroleum oils, such as aromatic and naphthenic oils; polyalkylbenzene oils; organic acid monoesters, such as alkyl and alkoxyalkyl oleates and stearates; organic acid diesters, such as dialkyl, dialkoxyalkyl, and alkyl aryl phthalates, terephthalates, sebacates, adipates, and glutarates; glycol diesters, such as tri-, tetra-, and polyethylene glycol dialkanoates; trialkyl trimellitates; trialkyl, trialkoxyalkyl, alkyl diaryl, and triaryl phosphates; chlorinated paraffin oils; coumarone-indene resins; pine tars; vegetable oils, such as castor, tall, rapeseed, and soybean oils and esters and epoxidized derivatives thereof; and the like.

Antioxidants and antiozonants include, but are not limited to, hindered phenols, bisphenols, and thiobisphenols; substituted hydroquinones; tris(alkylphenyl)phosphites; dialkylthiodipropionates; phenylnaphthylamines; substituted diphenylamines; dialkyl, alkyl aryl, and diaryl substituted p-phenylene diamines; monomeric and polymeric dihydroquinolines; 2-(4-hydroxy-3,5-t-butylaniline)-4,6-bis(octylthio)1,3,5-triazine, hexahydro-1,3,5-tris-β-(3,5-di-t-butyl-4-hydroxyphenyl)propionyl-s-triazine, 2,4,6-tris(n-1,4-dimethylpentylphenylene-diamino)-1,3,5-triazine, tris-(3,5-di-t-butyl-4-hydroxybenzyl)isocyanurate, nickel dibutyldithiocarbamate, 2-mercaptotolylimidazole and its zinc salt, petroleum waxes, and the like.

Blowing agents include, but are not limited to, decomposable chemical blowing agents. Such chemical blowing agents decompose at elevated temperatures to form gases or vapors to blow the polymer into foam form. The agent preferably takes a solid form, so it is conveniently dry-blended with the polymer material. Chemical blowing agents include, but are not limited to, azodicarbonamide, azodiisobutyro-nitrile, barium azodicarboxylate, N,N′-dimethyl-N,N′-dinitrosoterephthalamide, N,N′-dinitrosopentamethylenetetramine, benzenesulfonhydrazide, 4,4-oxybenzene sulfonyl semicarbazide, p-toluene sulfonyl semicarbazide, p,p′-oxybis-(benzenesulfonyl hydrazide), 3,3′-disulfonhydrazide-diphenylsulfone, azobisisobutyronitrile, azobisformamide and the like. In one embodiment, the blowing agent is azodicarbonamide. These blowing agents may be used alone or in admixture of two or more. In one embodiment, the blowing agent is an inorganic blowing agent, such as ammonium carbonate, sodium bicarbonate, anhydrous sodium nitrate, and the like.

Crosslinking agents include, but are not limited to, sulfur-containing compounds, such as elemental sulfur, 4,4′-dithiodimorpholine, thiuram di-and polysulfides, alkylphenol disulfides, and 2-morpholino-dithiobenzothiazole; metal oxides, such as zinc, magnesium, and lead oxides; dinitroso compounds, such as p-quinone-dioxime and p,p′-dibenzoylquinone-dioxime; and phenol-formaldehyde resins containing hydroxymethyl or halomethyl functional groups. Sulfur can be a crystalline elemental sulfur or an amorphous elemental sulfur, and either type can be in pure form or supported on an inert carrier. An example of a supported sulfur is RHENOGRAN S-80 (80% S) from Rhein Chemie. In one embodiment, the sulfur containing compounds are the preferred crosslinking agents,

The amount of the crosslinking agent can range from about 0.5 to 10 parts by weight, based upon 100 parts of the polymers in the composition. Crosslinking temperatures and time employed are typical. Temperatures ranging from about 250° F. to about 440° F., and times ranging from about one minute to about 120 minutes can be employed.

### Applications

The compositions of the present invention may be used to prepare a variety of articles or manufacture, or their component parts or portions. The inventive compositions are especially suited for foamed, crosslinked extruded profile applications, including automotive weather strip applications. The inventive compositions may be converted into a finished article of manufacture by any one of a number of conventional processes and apparatus. Illustrative processes include, but are not limited to, extrusion, calendering, compression molding, and other typical thermoset material forming processes. For example, articles can be prepared by extrusion, extrusion followed by additional thermal treatment, low pressure molding, compression molding, and the like.

Articles include, but are not limited to, foams, sheets, fibers, molded goods, and extruded parts. Additional articles include automotive parts, weather strips, belts, hoses, wire and cable jacketing, flooring materials, gaskets, tires and tire components, computer parts, building materials, household appliances, electrical supply housings, trash cans, storage or packaging containers, lawn mower parts and other garden appliance parts, acoustic devices, utility cart parts, desk edging, toys and water craft parts. The compositions can also be used in roofing applications, such as roofing membranes. The compositions can further be used in fabricating a footwear component, including, but not limited to, a shaft for a boot, particularly an industrial work boot. The compositions can also be used in fabricating automotive parts. A skilled artisan can readily augment this list without undue experimentation.

### Definitions

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure) and the term interpolymer as defined hereinafter.

The term “interpolymer,” as used herein, refers to polymers prepared by the polymerization of at least two different types of monomers. The term interpolymer thus includes the term copolymer (employed to refer to polymers prepared from two different types of monomers) and polymers prepared from more than two different types of monomers.

The term “ethylene-based polymer,” as used herein, refers to a polymer that comprises, in polymerized form, a majority weight percent of ethylene (based on the weight of the interpolymer), and optionally may comprise one or more comonomers.

The term “ethylene-based interpolymer,” as used herein, refers to a polymer that comprises, in polymerized form, a majority weight percent of ethylene (based on the weight of the interpolymer), and at least one comonomer.

The term “ethylene/α-olefin/polyene interpolymer,” as used herein, refers to a polymer that comprises, in polymerized form, ethylene, an α-olefin, and a polyene. In one embodiment, the “ethylene/α-olefin/polyene interpolymer,” comprises a majority weight percent of ethylene (based on the weight of the interpolymer).

The term “ethylene/α-olefin copolymer,” as used herein, refers to a polymer that comprises, in polymerized form, a majority weight percent of ethylene (based on the weight of the copolymer), an α-olefin, and no other comonomer type.

The term “phr,” as used herein, is in reference to weight of a compositional component relative to “hundred parts” of the ethylene/α-olefin/polyene interpolymer, and the ethylene/α-olefin copolymer.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

### Test Methods

### Mooney Viscosity

Interpolymer MV (ML1+4 at 100° C.) is measured in accordance with ASTM 1646-04, with a one minute preheat time and a four minute rotor operation time. The instrument is an Alpha Technologies Rheometer MDR 2000.

Interpolymer MV (ML1+4 at 125° C.) is measured in accordance with ASTM 1646-04, with a one minute preheat time and a four minute rotor operation time. The instrument is an Alpha Technologies Rheometer MDR 2000.

For an EAODM (preferably an EPDM) interpolymer containing a filler, the Mooney Viscosity [MV (ML1+4 at 125° C.)] for the neat interpolymer (no filler (for example, carbon black) and no oil) can be determined, by one skilled in the art, by one of two methods as described below. The following methods are in reference to carbon black filled interpolymers, however, one skilled in the art could use similar methods for other types of fillers. The following methods can also be modified by one skilled in the art to provide for the determination of Mooney viscosities at other temperatures and/or other test conditions, such as preheat time and/or rotor size.

### Method 1

For a carbon black filled interpolymer (INTA), preferably with no oil, or a known amount of oil (typically less than two weight percent, based on weight of interpolymer), and which has a measured viscosity less than 100 [MV (ML1+4 at 125° C.)], the Mooney viscosity of the neat interpolymer is determined from a calibration curve as follows. The amount of carbon black in the polymerized INT A interpolymer can be determined gravimetrically, for example, by selective ashing of the polymer (plus additives if present), and, if present, oil, in a manner to leave the carbon black intact (for example TGA).

A neat interpolymer, corresponding in chemical make-up to the interpolymer of interest, and prepared from the same or similar catalyst system, and of known Mooney viscosity [MV (ML1+4 at 125° C.)], is melt blended with various levels of carbon black, and, if needed, the required amount of oil, to form a range of carbon black filled interpolymers. Melt blending can be done in a Brabender mixer. The carbon black and oil used, are the same as that in the interpolymer of interest (INT A). The Mooney viscosity [MV (ML1+4 at 125° C.)] is measured for each sample, and a calibration curve is generated, showing the measured Mooney viscosity as a function of the amount of carbon black. A series of such calibration curves are generated for several neat interpolymers (no filler, no oil) of varying viscosities. The data from the generated calibration curves is entered into a regression program, such as a MICROSOFT EXCEL regression program, and the following information is generated: a coefficient for the carbon black level, a coefficient for the measured Mooney viscosity, and an intercept.

The Mooney viscosity [MV (ML1+4 at 125° C.)] of the neat interpolymer of interest can be calculated using the data generated from the regression analysis, the known level of carbon black in the interpolymer (INTA), and the measured Mooney viscosity [MV (ML1+4 at 125° C.)] of the interpolymer (INT A).

### Method 2

For a carbon black filled interpolymer (INT B), preferably with no oil, or a known amount of oil (typically less than two weight percent, based on the weight of the interpolymer), and which has a viscosity that is determined to be greater than, or equal to, 100 [MV (ML1+4 at 125° C.)], the Mooney viscosity of the neat polymer is determined from a calibration curve as follows. The amount of carbon black in the polymerized INT B interpolymer can be determined gravimetrically, for example, by selective ashing of the polymer (plus additives if present), and, if present, oil, in a manner to leave the carbon black intact (for example TGA).

A neat interpolymer, corresponding in chemical make-up to the interpolymer of interest, and prepared from the same or similar catalyst system, and of known polymer Mooney viscosity, is melt blended, with a fixed amount of carbon black (for example, from 40 to 60 phr carbon black, based on hundred parts interpolymer), and a fixed amount of an oil (for example, from 60 to 80 phr oil, based on hundred parts interpolymer), to form a first sample. The carbon black and oil used, are the same as that in the interpolymer of interest

(INTB). Additional samples are formed, each having an interpolymer of different Mooney viscosity, and each having the same amount of both carbon black and oil. The Mooney viscosity [MV (ML1+4 at 125° C.)] is measured for each sample. A calibration curve is generated, showing the measured Mooney viscosity [MV (ML1+4 at 125° C.)] as a function of the Mooney viscosity [MV (ML1+4 at 125° C.)] of the neat interpolymer (no filler, no oil).

The carbon-black filled interpolymer (INT B) of interest is next compounded with additional carbon black, to achieve a final carbon black level as that used in the samples for calibration, as discussed above. Also the “INT B” interpolymer is compounded with the same oil, and at the same oil level, as that used in the samples for calibration as discussed above, to form a “new compounded INT B” interpolymer. The Mooney viscosity [MV (ML1+4 at 125° C.)] of the “new compounded INT B” interpolymer is measured. The Mooney viscosity of the neat interpolymer can be then calculated using the calibration curve as described above.

Melt index (I2) of an ethylene-based polymer is measured in accordance with ASTM D-1238-04, condition 190° C./2.16 kg. Melt index (I5) of an ethylene-based polymer is measured in accordance with ASTM D-1238-04, condition 190° C./5.0 kg. Melt index (HO) of an ethylene-based polymer is measured in accordance with ASTM D-1238-04, condition 190° C./10.0 kg. High load melt index (I21) of an ethylene-based polymer is measured in accordance with ASTM D-1238-04, condition 190° C./21.0 kg.

Polymer density is measured in accordance with ASTM D-792-08. This test method can be used to measure density at elevated temperatures. For density at 100° C., the polymer sample and test liquid (glycerin) were heated to, and equilibrated at, 100° C.

Foam density is measured in accordance with ISO 1183-1 Ed. 2004.

### Compositions

All compositions were prepared in a HARBURG-FREUDENBERGER GK 1.5E intermeshing internal mixer with a “1.5 liter” volume. The temperature of the water in the heating jacket of the mixing chamber was 50° C. All components, excluding crosslinking agent(s) and blowing agent(s), were added at once, and mixed at varying rpm, to allow the formulation temperature to reach 95° C. The ram was lifted, crosslinking agent(s) and blowing agent(s) added, ram was swept and re-lowered, and the compound mixed for a further 60 seconds. After this time, the door below the mixer was opened to release the uncured compound into a receptacle.

Sheets of uncured compound approximately “5 mm” thick were obtained by passing the compound, obtained on the internal mixer, between the rolls of a “15 cm” two-roll mill, manufactured by J.R. Dare (model “300×150 mm” LAB MILL). The temperature of the water in the rolls was maintained at 60° C., and the roll speed was 20 rpm. Strips of unvulcanized rubber were obtained by extruding the uncured sheet from the above roll mill through a rectangular die (“25 mm×1 mm”). Extrusion was done on the HAAKE POLYLAB single screw extruder at 100° C., using 60 rpm screw speed. The unvulcanized sheets were cured and foamed in the hot air circulating oven (Mathis, Switzerland) for three minutes at 210° C. or 240° C.

Compound hardness was measured to Shore A, according to ISO 868:2003 at 23° C., using a machine manufactured by Zwick Roell (model 7206.07/00). The stylus contacted the cured specimen for three seconds before the reading was taken. The test specimens were cut from the cured and foamed strips, prepared by the above described extrusion and curing and blowing procedure. Sample dimensions were “25 mm×25 mm×2 mm,” and the samples were stacked to thickness of “6 mm” for the hardness measurement.

### Solubility Parameter

The solubility parameter of polymers, or polymers and solvents, is described in Krause S, Polymer-Polymer Compatibility, in Paul, D R, Polymer Blends, Academic Press Inc, London 1978 (hereinafter Krause). In Krause, a step-by-step model to predict compatibility is described, based on Small's group molar attraction constants. For each polymer, the solubility parameter is calculated from the density of the polymer at the temperature of interest, the molar mass of the repeat unit, and the sum of the group molar attraction constants for the monomeric repeat unit. The model can be used to calculate solubility parameters for random copolymers, by using the molar fractions of the various repeat units of the copolymer. See Formula A below:

δ=ρ×Σ(Fi/M) (Formula A).

In Formula A, δ is the solubility parameter, ρ is the density of the polymer at the temperature of interest, Fi is the sum of all the of the group molar attraction constants for the repeat unit, and M is the molar mass of the repeat unit.

For a blend of two polymers, the solubility of each polymer can be calculated. The molar attraction constant for the ethylene repeating unit is 266 (cal/cm³)“^{1/2}/mol, and the repeat unit weighs 28 grams/mol. Propylene repeat units have a molar attraction constant of 375 (cal/cm³)”^{1/2}/mol, and the repeat unit weighs 42 grams/mol. Octene repeat units have a molar attraction constant of 1040 (cal/cm³)^{1/2}/mol, and the repeat unit weighs 112 grams/mol. For simplicity, the contribution of the relatively small molar contribution of the ethlylidene norbornene cure site monomer in an EPDM is neglected. As an example, an amorphous EPDM polymer, with 45 wt % propylene (55 wt % ethylene), contains 35.3 mol % propylene and 64.7 mol % ethylene. The density of the polymer at 100° C. is 0.84g/cc.

The solubility parameter is therefore estimated as 0.84*((0.353*375/42)+(0.647*266/28)), which equals 7.81 (cal/cm³)^{1/2}.

For each an ethylene/α-olefin/polyene interpolymer the density at 100° C. was used to determine the solubility parameter. For each ethylene/α-olefin copolymer the density at 100° C. was used to determine the solubility parameter.

It has been discovered, that suitable elastomer blends (or compositions) for crosslinked foams with good mechanical properties result when absolute difference in the solubility parameters of the polymers is less than, or equal to, 0.15 (cal/cm³)^{1/2}. Also, in the preferred compositions, one polymer (Component B) is nonreactive with the crosslinking agent used to form the crosslinked foam.

### Experimental

EPDM 140 is an ethylene/propylene/diene (ENB) that has a Mooney Viscosity from 133 to 147 (calculated for ML1+4 at 125° C. (polymer)) ASTM D1646), 32 mole % propylene, and contains from 22 to 26 phr carbon black. Density at 100° C. was 0.84 g/cc (1 cc=1 cm³).

EPDM 565 is an ethylene/propylene/diene (ENB) that has a Mooney Viscosity from 61 to 69 (ML1+4 at 125° C., ASTM D1646), 39 mole % propylene. Density at 100° C. was 0.84 g/cc.

EO 03 is an ethylene/octene-1 copolymer that has a density (rm. temp.) from 0.882 to 0.888 g/cc (ASTM D 792 (ASTM D4703, Al Proc C, test within one hour)), and a melt index from 0.75 to 1.25 (ASTM D1238, 190° C., 2.16 kg), 9 mole % octene. Density at 100° C. was 0.84 g/cc. Homogeneously branched substantially linear copolymer.

EO 45 is an ethylene/octene-1 copolymer that has a density (rm. temp.) from 0.9180 to 0.9220 g/cc (ASTM D 792 (ASTM D4703, A1 Proc C, test within one hour)), and a melt index from 0.81 to 1.15 (ASTM D1238, 190° C., 2.16 kg), 2.4 mole % octene. Density at 100° C. was 0.84 g/cc. Heterogeneously branched linear copolymer (LLDPE).

SPHERON 5000 is carbon black available from Cabot Corporation.

OMYA SH CaCO3 is calcium carbonate available from Omya GmbH.

CARBOWAX PEG 4000 is polyethylene glycol available from The Dow Chemical Company.

RHENOGRAN S-80 is 80% sulfur and 20% elastomer binder and dispersing agents, available from Rhein Chemie.

RHENOGRAN ZAT-70 is 70% zinc amine dithiophosphate and 30% elastomer binder and dispersing agent, available from Rhein Chemie.

RHENOGRAN MBT-80 is 80% 2-mercapto-benzthiazol acc. to specification and 20% elastomer binder and dispersing agents, available from Rhein Chemie.

RHENOGRAN ZBEC-70 is 70% zinc-dibenzyl-dithiocarbamate (techn.) and 30% elastomer binder and dispersing agents, available from Rhein Chemie.

RHENOGRAN ZBOP-50 is 50% zinc-dialkyldithiophosphate (selected molecular structure) and 50% polymer binder and dispersants, available from Rhein Chemie.

RHENOGRAN CaO-80 is 80% calcium oxide and 20% elastomer binder and dispersing agents, available from Rhein Chemie.

POROFOR ADC/L-C2 is an azodicarbonic acid diamide preparation available from Lanxess.

RHENOSLAB OBSH-75 is 75% oxy-bis benzene sulfonyl hydrazide and 25% EPDM/EVA binder, available Rhein Chemie.

### Example 1

The composition, as shown in Table 1, was mixed in HARBURG &

FREUDENBERGER internal mixer at 100° C., and subsequently on the open mill at 60° C., to form a “5 mm thick” unvulcanized rubber sheet. The unvulcanized rubber was extruded through a Garvey die at 100° C., to form a rubber profile. The rubber profile was cured and foamed in a hot air oven at 210° C. and 240° C., to form two crosslinked, foam samples. The foam, prepared from the extruded rubber profile crosslinked and foamed at 210° C., had Shore A Hardness of 57.4±1.5, and a density of 1.01 g/cm3. The foam, prepared from the extruded rubber profile crosslinked and foamed at 240° C., had Shore A hardness of 50.0±1.2, and a density of 0.90 g/cm³. The polymer components in this example, EPDM 140 and EO 03 have the difference in the solubility parameter of 0.137 (cal/cm³)^{1/2}.

TABLE 1
Composition (Inventive Example 1)

| Component | phr* |
|---|---|
| EPDM 140 | 108.97 |
| EO 03 | 15.00 |
| SPHERON 5000 | 113.92 |
| Oil | 90.00 |
| OMYA SH CaCO3 | 56.96 |
| Stearic Acid | 0.95 |
| CARBOWAX PEG 4000 | 1.90 |
| ZnO | 4.75 |
| RHENOGRAN S-80 | 1.52 |
| RHENOGRAN ZAT-70 | 0.95 |
| RHENOGRAN MBT-80 | 0.95 |
| RHENOGRAN ZBEC-70 | 1.90 |
| RHENOGRAN ZBOP-50 | 2.85 |
| RHENOGRAN CaO-80 | 4.75 |
| POROFOR ADC/L-C2 | 1.42 |
| RHENOSLAB OBSH-75 | 1.42 |

*phr based on amount of EPDM 140 and EO 03.

### Comparative Example 2

The composition, as shown in Table 2, was mixed in HARBURG & FREUDENBERGER internal mixer at 100° C., and subsequently on the open mill at 60° C., to form a “5 mm thick” unvulcanized rubber sheet. The unvulcanized rubber was extruded through a Garvey die at 100° C., to form a unvulcanized rubber profile. The unvulcanized rubber profile was cured and foamed in a hot air oven at 210° C. and 240° C., to form two crosslinked, foam samples. The polymer components in this example, EPDM 140 and EPDM 565 have the difference in the solubility parameter of 0.034 (cal/cm³)^{1/2}.

TABLE 2
Composition (Comparative Example 2)

| Component | phr* |
|---|---|
| EPDM 565 | 23.73 |
| EPDM 140 | 97.78 |
| SPHERON 5000 | 113.92 |
| Oil | 90.00 |
| OMYA SH CaCO3 | 56.96 |
| Stearic Acid | 0.95 |
| CARBOWAX PEG 4000 | 1.90 |
| ZnO | 4.75 |
| RHENOGRAN S-80 | 1.52 |
| RHENOGRAN ZAT-70 | 0.95 |
| RHENOGRAN MBT-80 | 0.95 |
| RHENOGRAN ZBEC-70 | 1.90 |
| RHENOGRAN ZBOP-50 | 2.85 |
| RHENOGRAN CaO-80 | 4.75 |
| POROFOR ADC/L-C2 | 1.42 |
| RHENOSLAB OBSH-75 | 1.42 |

*phr based on amount of EPDM 140 and EPDM 565.

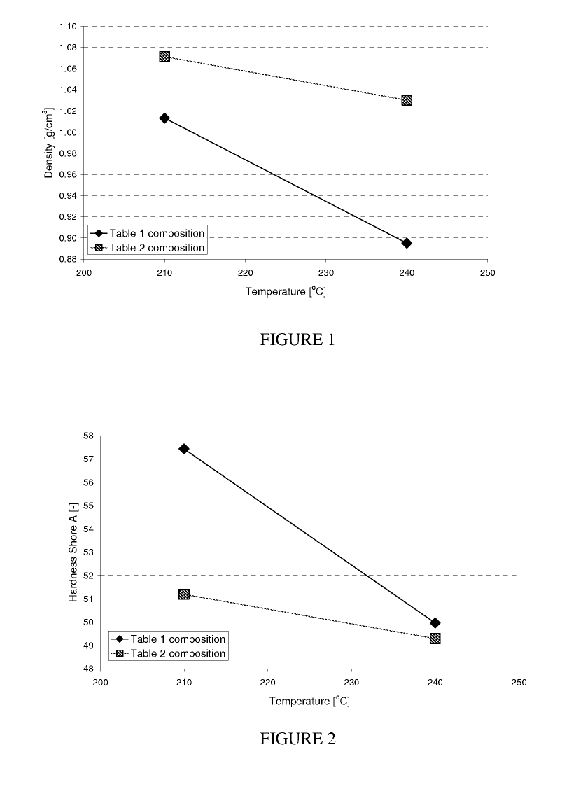

The density and Shore A Hardness of each comparative foam was measured, and compared to the foam of Example 1. See FIGS. 1 and 2. The foams of Example 1 had lower densities than the corresponding foams of Comparative Example 2, at both curing temperatures. The inventive foams also had higher, or equivalent, Shore A Hardness values. The combination of lower density and higher hardness, as seen in the inventive foams, is a desirable improvement in the manufacture of foams.

### Comparative Example 3

The composition, as shown in Table 3, was mixed in HARBURG & FREUDENBERGER internal mixer at 100° C., and subsequently on the open mill at 60° C., to form a “5 mm thick” unvulcanized rubber sheet. The unvulcanized rubber was extruded through a rectangular die at 100° C., to form a unvulcanized rubber profile. The unvulcanized rubber profile was cured and foamed in a hot air oven at 240° C., to form crosslinked, foam sample.

TABLE 3
Composition (Comparative Example 3)

| Component | phr* |
|---|---|
| EPDM 565 | 85.00 |
| EO 45 | 15.00 |
| SPHERON 5000 | 113.92 |
| Oil | 90.00 |
| OMYA SH CaCO3 | 56.96 |
| Stearic Acid | 0.95 |
| CARBOWAX PEG 4000 | 1.90 |
| ZnO | 4.75 |
| RHENOGRAN S-80 | 1.52 |
| RHENOGRAN ZAT-70 | 0.95 |
| RHENOGRAN MBT-80 | 0.95 |
| RHENOGRAN ZBEC-70 | 1.90 |
| RHENOGRAN ZBOP-50 | 2.85 |
| RHENOGRAN CaO-80 | 4.75 |
| POROFOR ADC/L-C2 | 1.42 |
| RHENOSLAB OBSH-75 | 1.42 |

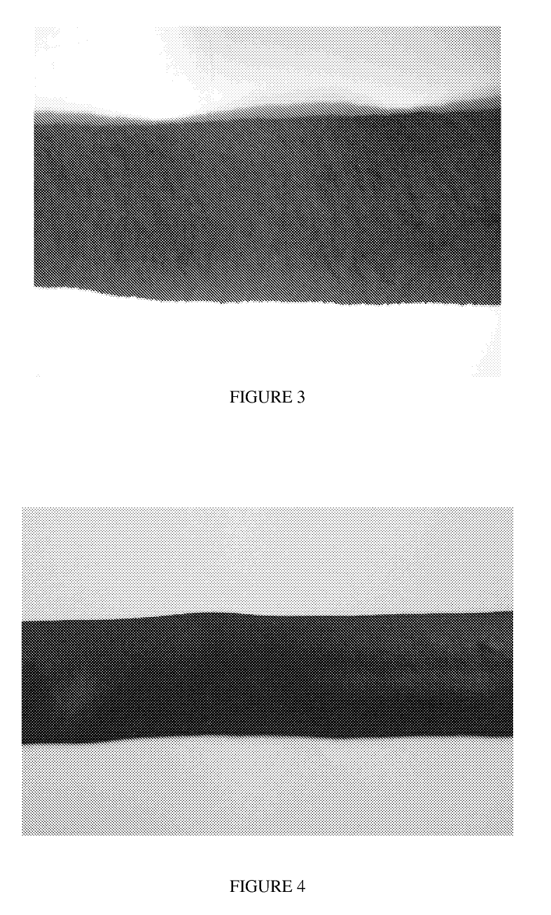

The polymer components in this comparative example, EPDM 565 and EO 45 have the difference in the solubility parameter of 0.183 (cal/cm³)^{1/2}. Due to the unfavorable difference in solubility parameter, EO 45 was not fully dispersed within the EPDM matrix, causing uneven blowing of the vulcanized profile. In addition the sample showed extensive surface shrinkage, making the composition unsuitable for any typical foam application (see FIG. 3).

As shown in FIG. 3, which is the top surface view (¾ inch wide) of a foamed formed from Comparative Example 3, the foam surface is rough, and upper and lower foam edges are rough and broken. This foam is unacceptable for an automotive weather strip application. FIG. 4 is top surface view (¾ inch wide) of a foam formed from Inventive Example 1. As shown in this figure, the foam surface is glossy and smooth, and the upper and lower edges are sharp and smooth. This foam is highly acceptable for an automotive weather strip application.

Although the invention has been described in considerable detail in the preceding examples, this detail is for the purpose of illustration, and is not to be construed as a limitation on the invention as described in the following claims.

1. A composition comprising at least the following:
A) an ethylene/α-olefin/polyene interpolymer,
B) an ethylene/α-olefin copolymer,
C) optionally at least one filler,
D) at least one crosslinking agent,
E) at least one blowing agent.

2. The composition of claim 1, wherein the absolute difference in the solubility parameters between the component A and component B is less than, or equal to, 0.15 (cal/cm³)^{1/2}.

3. The composition of claim 1, wherein component A is present in an amount greater than, or equal to, 75 weight percent, based on the weight of component A and component B.

4. The composition of claim 1, wherein components A and B comprise at least 80 weight percent, based on the weight of all the polymer components of the composition.

5. The composition of claim 1, wherein component A is present in an amount greater than 15 weight percent, based on the weight of the composition.

6. The composition of claim 1, wherein component B is present in an amount from 1 weight percent to 10 weight percent, based on the weight of the composition.

7. The composition of claim 1, wherein the weight ratio of “component A/component B” is from 2/1 to 10/1.

8. The composition of claim 1, wherein the ethylene/α-olefin copolymer is a homogeneously branched linear ethylene/α-olefin copolymer or a homogeneously branched substantially linear ethylene/α-olefin copolymer.

9. The composition of claim 8, wherein the ethylene/α-olefin copolymer is a homogeneously branched substantially linear ethylene/α-olefin copolymer.

10. An article comprising at least one component formed from the composition of claim 1.

11. The article of claim 10, wherein the article is an automotive part.

12. A crosslinked foam formed from the composition of claim 1.

13. An article comprising at least one component formed from the crosslinked foam of claim 12.

14. The article of claim 13, wherein the article is an automotive part.
